(19) United States
(12) Patent Application Publication
(10) Pub. No.: US 2023/0237093 A1
(43) Pub. Date: Jul. 27, 2023

(54) VIDEO RECOMMENDER SYSTEM BY KNOWLEDGE BASED MULTI-MODAL GRAPH NEURAL NETWORKS

(71) Applicant: ADOBE INC., SAN JOSE, CA (US)

(72) Inventors: Yifan Li, Dallas, TX (US); Trung Huu Bui, San Jose, CA (US); Timothy Jeewun Ganter, Woodinville, WA (US); David Fox, New York, NY (US)

(21) Appl. No.: 17/649,091

(22) Filed: Jan. 27, 2022

(51) Int. Cl. G06F 16/735; G06N 3/08

(52) U.S. Cl. CPC G06F 16/735; G06N 3/08

(57) ABSTRACT

Systems and methods for item recommendation are described. Embodiments of the present disclosure receive input indicating a relationship between a user and a first content item; generate a knowledge graph based on the input, wherein the knowledge graph comprises relationship information between the user and a plurality of content items; generate a first feature embedding representing the user and a second feature embedding representing a second content item of the plurality of content items based on the knowledge graph, wherein the second feature embedding is generated using a first modality for a query vector of an attention mechanism and a second modality for a key vector and a value vector of the attention mechanism; compare the first feature embedding to the second feature embedding to obtain a similarity score; and recommend the second content item for the user based on the similarity score.

### BACKGROUND

The following relates generally to item recommendation, and more specifically to video recommendation using machine learning.

Item recommendation refers to the task of collecting data relating to user interactions, modeling user behavior, and using the model to predict items that users are likely to interact with. For example, the user may click on a sequence of items in an online store, and a website server can predict a next item that the user is likely to view or purchase.

Video recommendation is a subtask within the field of item recommendation where a video item is suggested to users to view. A video recommendation system generates a video recommendation based on a user profile when a user logs on to a video-sharing platform. In some examples, the user profile includes past interactions, preferred genres, or general browsing history on the internet. Additionally or alternatively, after a user watches a video, a set of related videos are presented on the side such that the user can move on to the next video of interest in a single click.

In some cases, neural networks such as transformer-based networks are used to generate recommendations. However, conventional recommendation systems encounter sparse interactions between users and videos due to the size of data and are unable to process different types of information for efficient recommendation (e.g., different modalities such as textual, visual, acoustic information). Therefore, there is a need in the art for an improved recommendation network that can be trained to model multi-modal information and recommend highly relevant videos.

### SUMMARY

The present disclosure describes systems and methods for video recommendation. Embodiments of the present disclosure include an item recommendation apparatus configured to generate a knowledge graph based on a user and a set of content items represented as nodes in the knowledge graph. In some cases, a knowledge graph includes a spatial encoding matrix representing a number of hops between nodes of the knowledge graph, and an edge encoding matrix representing edge types between the nodes. In some embodiments, a multi-modal graph encoder of the item recommendation apparatus generates a first feature embedding representing a user and a second feature embedding representing a content item based on the knowledge graph. The second feature embedding is generated using a first modality (e.g., textual information) for a query vector of an attention mechanism and a second modality (e.g., visual information) for a key vector and a value vector of the attention mechanism. In some examples, the multi-modal graph encoder can be trained using a contrastive learning loss and a ranking loss.

A method, apparatus, and non-transitory computer readable medium for item recommendation are described. One or more embodiments of the method, apparatus, and non-transitory computer readable medium include receiving input indicating a relationship between a user and a first content item; generating a knowledge graph based on the input, wherein the knowledge graph comprises relationship information between a node representing the user and a plurality of nodes corresponding to a plurality of content items including the first content item; generating a first feature embedding representing the user and a second feature embedding representing a second content item of the plurality of content items using a multi-modal graph encoder based on the knowledge graph, wherein the second feature embedding is generated using a first modality for a query vector of an attention mechanism and a second modality for a key vector and a value vector of the attention mechanism; comparing the first feature embedding to the second feature embedding to obtain a similarity score between the user and the second content item; and recommending the second content item for the user based on the similarity score.

A method, apparatus, and non-transitory computer readable medium for training a neural network are described. One or more embodiments of the method, apparatus, and non-transitory computer readable medium include receiving training data including relationships between a plurality of users and a plurality of content items; generating a knowledge graph based on the training data, wherein the knowledge graph represents the relationships between the plurality of users and the plurality of content items; generating a first feature embedding representing a user and a second feature embedding representing a content item of the plurality of content items using a multi-modal graph encoder based on the knowledge graph, wherein the second feature embedding is generated using a first modality as a query vector of an attention mechanism and a second modality as a key vector of the attention mechanism; computing a loss function based on the first feature embedding and the second feature embedding; and updating parameters of the multi-modal graph encoder based on the loss function.

An apparatus and method for item recommendation are described. One or more embodiments of the apparatus and method include a knowledge graph component configured to generate a knowledge graph representing relationships between a plurality of users and a plurality of content items; a multi-modal graph encoder configured to generate a first feature embedding representing a user and a second feature embedding representing a content item of the plurality of content items based on the knowledge graph, wherein the second feature embedding is generated using a first modality for a query vector of an attention mechanism and a second modality for a key vector and a value vector of the attention mechanism; and a recommendation component configured to compare the first feature embedding to the second feature embedding to obtain similarity scores between the users and the content items and to identify recommended content items to the users based on the similarity scores.

### BRIEF DESCRIPTION OF THE DRAWINGS

FIG. 1 shows an example of an item recommendation system according to aspects of the present disclosure.

FIG. 2 shows an example of recommending a content item according to aspects of the present disclosure.

FIG. 3 shows an example of multi-modal information as input according to aspects of the present disclosure.

FIG. 4 shows an example of a video recommendation application according to aspects of the present disclosure.

FIG. 5 shows an example of an item recommendation apparatus according to aspects of the present disclosure.

FIG. 6 shows an example of a machine learning model for item recommendation according to aspects of the present disclosure.

FIG. 7 shows an example of a multi-modal graph encoder according to aspects of the present disclosure.

FIG. 8 shows an example of recommending a content item according to aspects of the present disclosure.

FIG. 9 shows an example of item recommendation using a machine learning model according to aspects of the present disclosure.

FIG. 10 shows an example of generating a multi-modal feature embedding according to aspects of the present disclosure.

FIG. 11 shows an example of generating a symmetric feature embedding according to aspects of the present disclosure.

FIG. 12 shows an example of training a neural network according to aspects of the present disclosure.

FIG. 13 shows an example of training a multi-modal graph encoder based on a ranking loss according to aspects of the present disclosure.

FIG. 14 shows an example of training a multi-modal graph encoder using contrastive learning according to aspects of the present disclosure.

### DETAILED DESCRIPTION

The present disclosure describes systems and methods for video recommendation. Embodiments of the present disclosure include an item recommendation apparatus configured to generate a knowledge graph based on a user and a set of content items represented as nodes in the knowledge graph. In some cases, a knowledge graph includes a spatial encoding matrix representing a number of hops between nodes of the knowledge graph, and an edge encoding matrix representing edge types between the nodes. In some embodiments, a multi-modal graph encoder of the item recommendation apparatus generates a first feature embedding representing a user and a second feature embedding representing a content item based on the knowledge graph. The second feature embedding is generated using a first modality (e.g., textual information) for a query vector of an attention mechanism and a second modality (e.g., visual information) for a key vector and a value vector of the attention mechanism. In some examples, the multi-modal graph encoder can be trained using a contrastive learning loss and a ranking loss.

Conventional recommendation networks are content-based or collaborative-filtering-based systems. In some examples, content-based networks generate vector representations in the Euclidean space based on input information and measure their similarities based on the vector representations. Alternatively, collaborative filtering-based systems treat each user-item interaction as an independent instance and encode side information.

However, conventional recommendation systems are not scalable to handle different types or sizes of input data and these systems may face cold start issues. In some examples, content-based systems are not able to provide recommendations based on sparse data (i.e., the interactions between users and content items are sparse due to large size of data). Similarly, collaborative filter-based systems have difficulty recommending relevant videos to a new user (i.e., cold start issue). As a result, performance of existing recommendation systems may not meet user expectations because the quality of personalized recommendations is decreased.

Embodiments of the present disclosure include a multi-modal graph encoder using a knowledge graph to model relationships among a set of nodes (i.e., users and content items). Some embodiments generate a knowledge graph including relationship information between a node representing a user and nodes corresponding to a set of content items. A knowledge graph captures node-edge relationship (i.e., entity-relation structure) connecting items with their corresponding attributes in a non-Euclidean space. In some examples, the knowledge graph includes both homogenous information and heterogenous information. For example, entities such as users and content items (represented as nodes in a knowledge graph) can be different types of objects.

By using a symmetric bi-modal attention network, embodiments of the present disclosure generate a first feature embedding representing the user and a second feature embedding representing a content item of the content items based on the knowledge graph. The second feature embedding is generated using a first modality for a query vector of an attention mechanism and a second modality for a key vector and a value vector of the attention mechanism. That is, a multi-modal graph encoder can handle input information of different types (i.e., modalities such as visual, textual, or acoustic information) where each modality has its own multi-head attention module. In some examples, the query, and (key, value) pair are constructed using input from different modalities. For example, the embedding from a first modality (i.e., modality 1) is used as the query input for a second modality (i.e., modality 2) multi-head attention unit, while the embedding in the second modality (modality 2) is used as the query input for the first modality (modality 1) multi-head attention unit. Therefore, multi-modal graph encoder is able to handle parallel sequential inputs, such as videos/transcripts, video/sound, etc. In some examples, the multi-modal graph encoder is trained using a multi-task loss function. The multi-mask loss includes a Bayesian personalized ranking loss and a metric loss function.

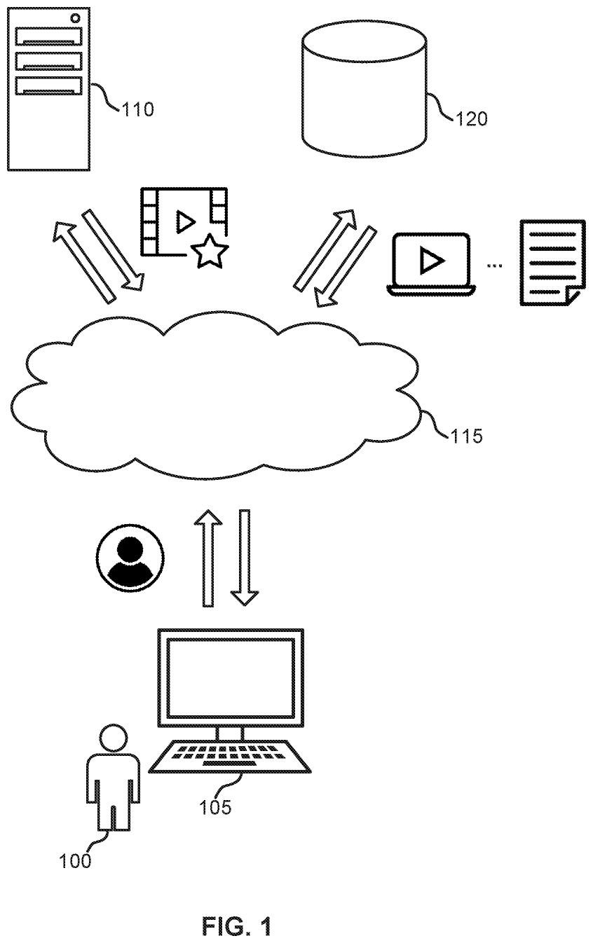

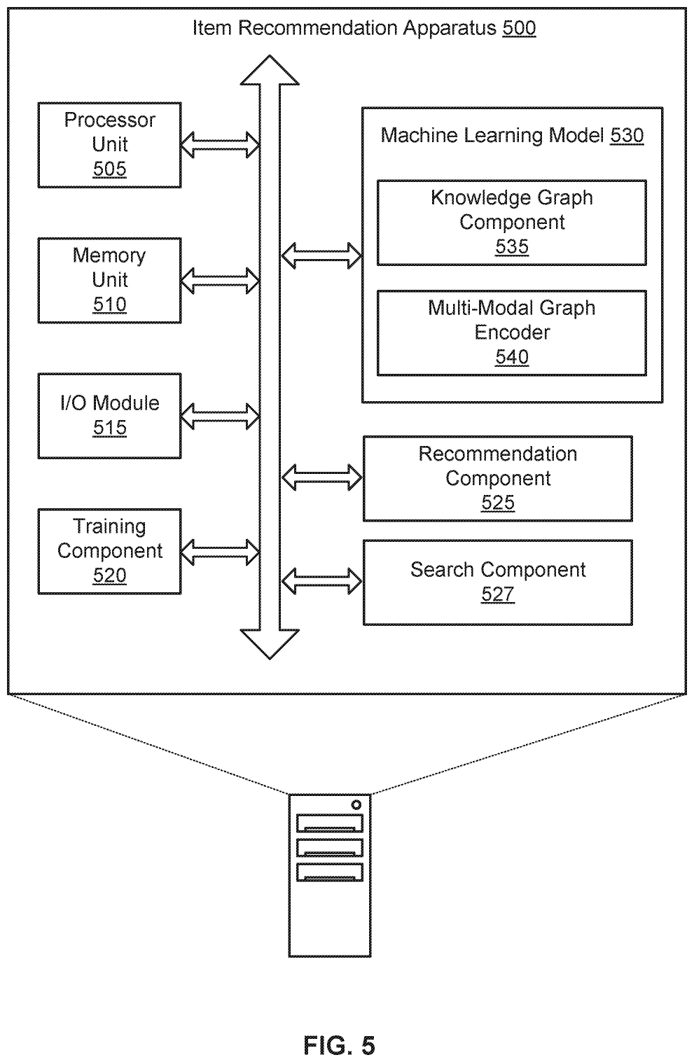

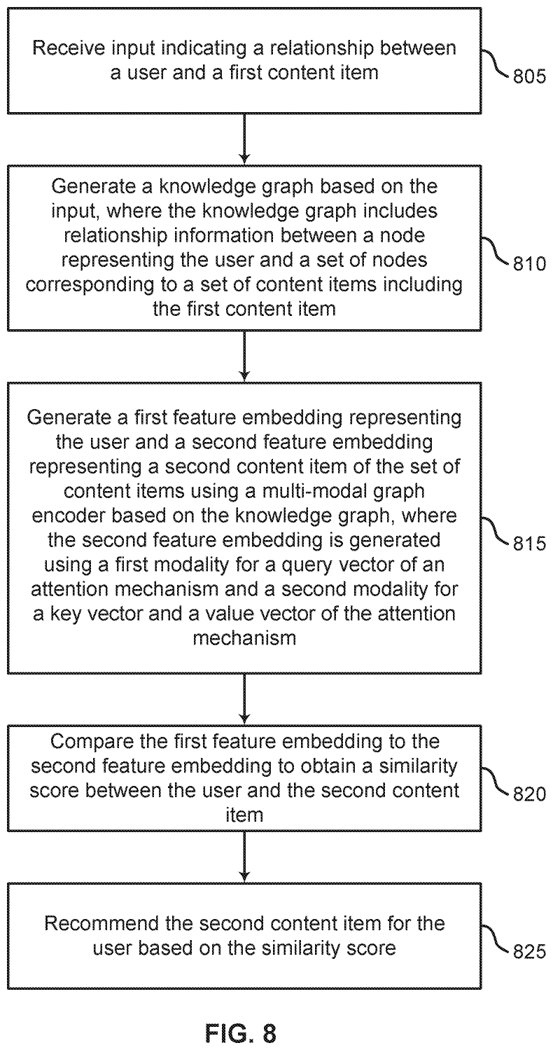

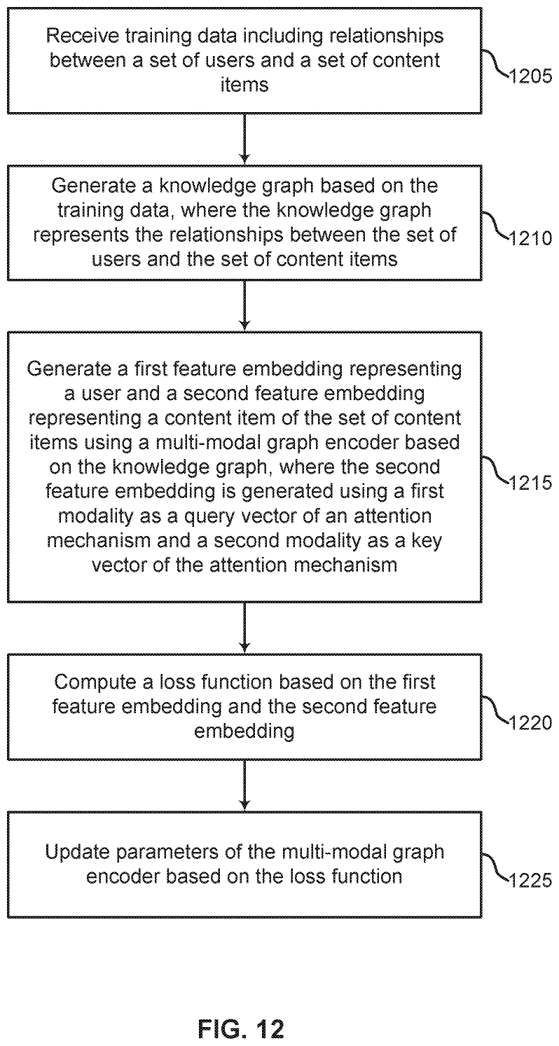

Embodiments of the present disclosure may be used in the context of content recommendation applications. For example, an item recommendation network based on the present disclosure may take different types of information as input and efficiently identify content items to be recommended to users to increase user interaction. An example application of the inventive concept in the video recommendation context is provided with reference to FIGS. 1-4. Details regarding the architecture of an item recommendation apparatus are provided with reference to FIGS. 5-7. Example processes for item recommendation are provided with reference to FIGS. 8-11. Example training processes are described with reference to FIGS. 12-14.

### Content Recommendation Application

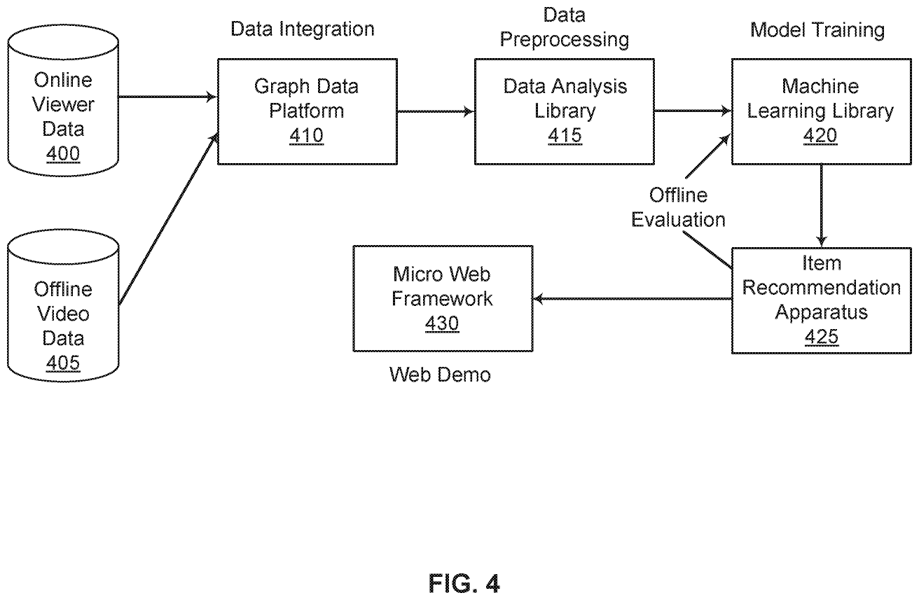

FIG. 1 shows an example of an item recommendation system according to aspects of the present disclosure. The example shown includes user 100, user device 105, item recommendation apparatus 110, cloud 115, and database 120. Item recommendation apparatus 110 is an example of, or includes aspects of, the corresponding element described with reference to FIGS. 4 and 5.

In the example of FIG. 1, user 100 interacts with a set of items on a streaming platform, e.g., using user device 105. In some examples, the set of items includes different types of media (e.g., audio files, video files, text files, and image files) that are presented on the streaming platform. User 100 communicates with item recommendation apparatus 110 via user device 105 and cloud 115. User device 105 transmits the user browsing history and user profile (i.e., denoted by the user profile icon in this example) to item recommendation apparatus 110 which generates and returns recommendations to the user.

User device 105 may be a personal computer, laptop computer, mainframe computer, palmtop computer, personal assistant, mobile device, or any other suitable processing apparatus. In some examples, user device 105 includes software that incorporates a content recommendation application. In some examples, the content recommendation application on user device 105 may include functions of item recommendation apparatus 110.

A user interface may enable user 100 to interact with user device 105. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a user interface may be represented in code which is sent to user device 105 and rendered locally by a browser.

Item recommendation apparatus 110 collects user profile information of user 100 and browsing history. In some examples, the browsing history includes at least one video viewed by the user previously (i.e., a cover page of the video shows visual information such as title, date, duration of the video). Each of the at least one video has an associated transcript (i.e., textual information including a short summary of the video). The content of the at least one video includes an audio feed (i.e., acoustic information). Item recommendation apparatus 110 receives input indicating a relationship between user 100 and a first content item. The multi-modal information is represented by a media play icon and a document icon (i.e., visual and textual information). For example, browsing history may correspond to a list of searchable content items stored within database 120. A data structure such as an array, a matrix, a tuple, a list, a tree, or a combination thereof may be used to represent the list of content items. The item recommendation apparatus 110 generates knowledge graph based on the input, where the knowledge graph indicates relationship information between a user and a set of content items including the first content item.

Item recommendation apparatus 110 generates a first feature embedding representing user 100 and a second feature embedding representing a second content item (e.g., a video) based on the knowledge graph. The second feature embedding is generated using a first modality for a query vector of an attention mechanism and a second modality for a key vector and a value vector of the attention mechanism. Item recommendation apparatus 110 compares the first feature embedding to the second feature embedding to obtain a similarity score between user 100 and the second content item.

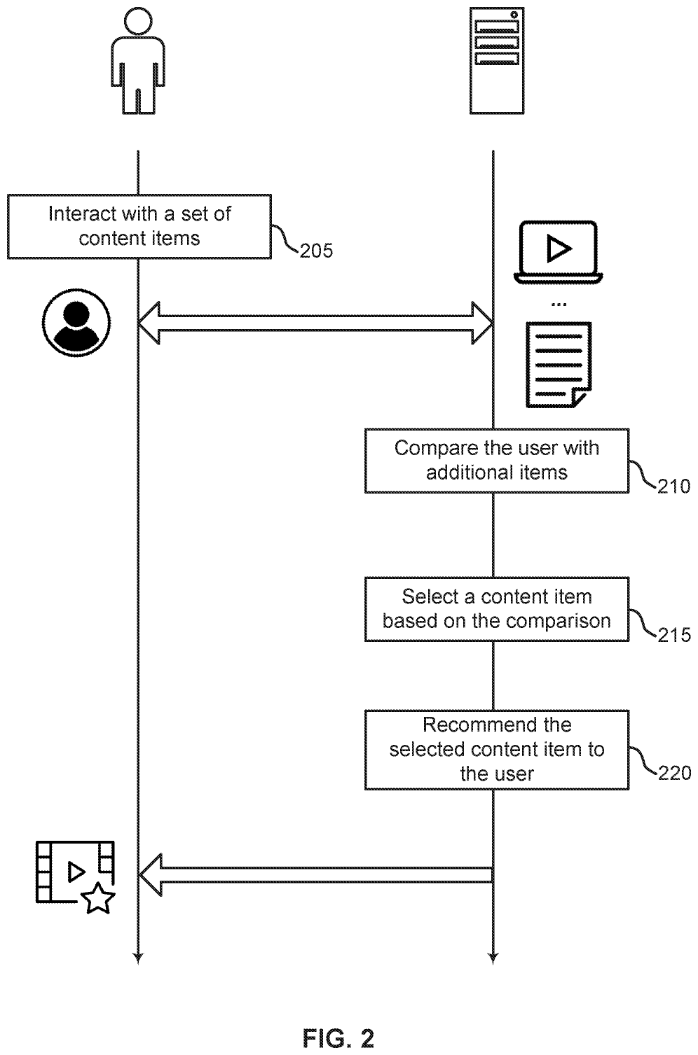

Item recommendation apparatus 110 recommends the second content item for user 100 based on the similarity score and returns the second content item (denoted as a favorite video icon) to user 100. Alternatively or additionally, item recommendation apparatus 110 displays a content item on a user interface similar to a video currently being viewed on a streaming platform. The process of using item recommendation apparatus 110 is further described with reference to FIG. 2.

Item recommendation apparatus 110 includes a computer implemented network comprising a knowledge graph component and a multi-modal graph encoder. Item recommendation apparatus 110 may also include a processor unit, a memory unit, an I/O module, a training component, and a recommendation component. The training component is used to train a machine learning model (or an item recommendation network). Additionally, item recommendation apparatus 110 can communicate with database 120 via cloud 115. In some cases, the architecture of the item recommendation network is also referred to as a network or a network model for brevity. Further detail regarding the architecture of item recommendation apparatus 110 is provided with reference to FIGS. 5-7. Further detail regarding the operation of item recommendation apparatus 110 is provided with reference to FIGS. 8-11.

In some cases, item recommendation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

A cloud 115 is a computer network configured to provide on-demand availability of computer system resources, such as data storage and computing power. In some examples, the cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud 115 is limited to a single organization. In other examples, the cloud 115 is available to many organizations. In one example, a cloud 115 includes a multi-layer communications network comprising multiple edge routers and core routers. In another example, a cloud 115 is based on a local collection of switches in a single physical location.

A database 120 is an organized collection of data. For example, database 120 stores content items of different modalities (e.g., video files, text files, audio files) in a specified format known as a schema. In some cases, a content item includes multiple types of information, e.g., a video can have audio, visual information, and transcript (i.e., text). A database 120 may be structured as a single database, a distributed database, multiple distributed databases, or an emergency backup database. In some cases, a database controller may manage data storage and processing in a database 120. In some cases, a user interacts with a database controller. In other cases, a database controller may operate automatically without user interaction.

FIG. 2 shows an example of recommending a content item according to aspects of the present disclosure. The item recommendation apparatus can be used on a web platform (e.g., streaming or video sharing platform) to perform content recommendation based on a user profile and/or videos previously viewed. In some examples, a user is interested in receiving personalized recommendations when logging on to a website. The item recommendation apparatus recommends a set of content items that are relevant and of interest to the user. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, a user interacts with a set of content items. In some cases, the operations of this step refer to, or may be performed by, user as described with reference to FIG. 1. In some cases, software platforms (e.g., Adobe®) provide video-sharing services. A user relies on personalized recommendations on a video-sharing and social media platform. For example, the user watches a video item on a streaming platform. The “browsing history” is represented by a video play icon and a document icon as in the example illustrated in FIG. 2. In some cases, the “video play” icon and the “document” icon are also used to represent content items having different types of information (visual, textual, acoustic information, etc.). In some cases, a content item can transmit multiple types of information to users, e.g., a video can provide audio, visual information, and transcript (i.e., text).

At operation 210, the system compares the user with additional items based on the interaction. The additional items may include different types of modalities (e.g., textual, visual, and acoustics information). In some cases, the operations of this step refer to, or may be performed by, item recommendation apparatus as described with reference to FIGS. 1, 4, and 5. In some examples, the user logs on to a website, the item recommendation apparatus implemented on the website server compares the user with a set of videos in the database, chooses and displays a portion of the videos tailored to the user on the main page. Such personalized recommendations consider the user's browsing history in the past and the user's connections with other users (e.g., user A may follow user B and/or a playlist of user B), etc. The item recommendation apparatus has access to multi-modal information (e.g., textual, visual, and acoustics information) stored in an external database or a database associated with the website server.

At operation 215, the system selects a content item based on the comparison. In some cases, the operations of this step refer to, or may be performed by, item recommendation apparatus as described with reference to FIGS. 1, 4, and 5. When the user watches a video, a list of related videos can be provided on the side to help the user locate the next video of interest in a single click. The above scenarios are categorized as video recommendations for users and video recommendations for videos.

At operation 220, the system recommends the selected content item to the user. In some cases, the operations of this step refer to, or may be performed by, item recommendation apparatus as described with reference to FIGS. 1, 4, and 5. According to the example above, the system provides the user with a content item (e.g., a starred video icon showing a video the user is likely interested in) as a recommended content item. The system displays the recommended video at a related video section on the website. The user can click on the recommended video and start to watch it.

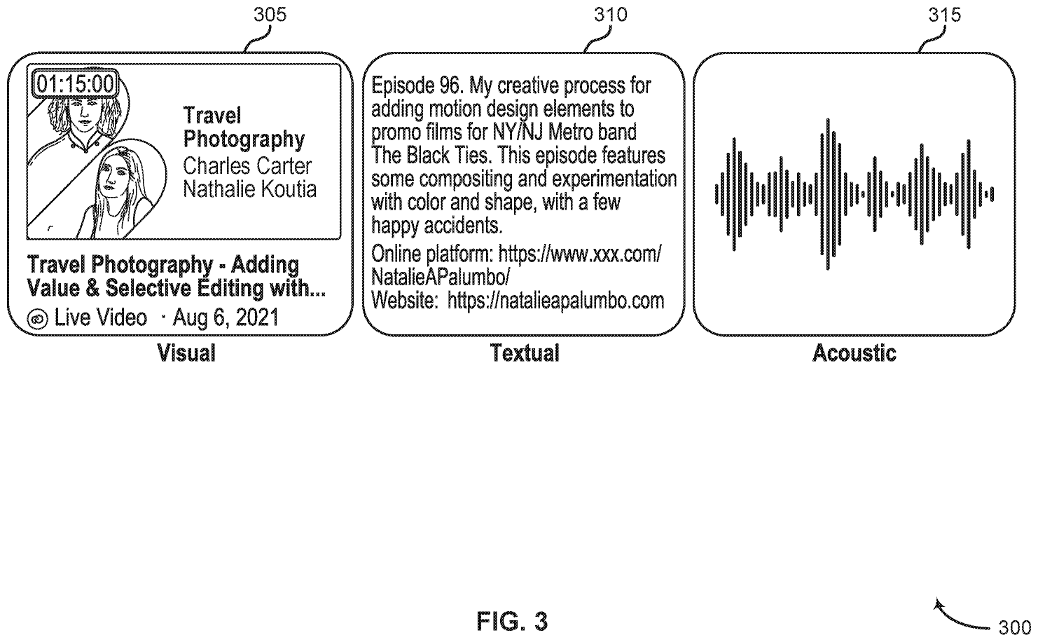

FIG. 3 shows an example of multi-modal information 300 as input to a multi-modal graph encoder according to aspects of the present disclosure. Item recommendation apparatus 110 described in FIG. 1 receives multi-modal information (e.g., visual, textual) from a database and can encode the multi-modal information. The example shown includes multi-modal information 300, which further includes visual information 305, textual information 310, and acoustic information 315. In some examples, multi-modal information 300 includes visual information 305, textual information 310, and/or acoustic information 315, however, embodiments of the present disclosure are not limited to the above-mentioned modalities of information.

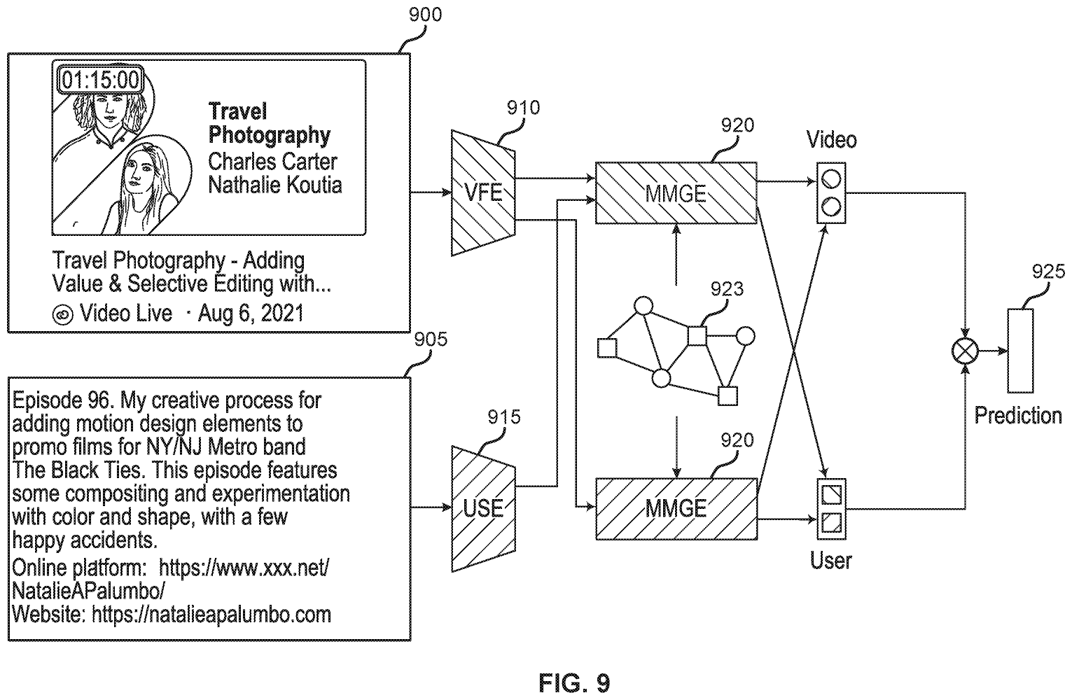

The item recommendation network can have different types of information as input. In some cases, the network takes features and multi-modal information as input for generating recommendations (e.g., recommendations for users, videos). For example, features may include video information such as upload time, application name, etc., and user information such as username, view history, etc. According to an embodiment, multi-modal information 300 includes visual information 305, textual information 310, and/or acoustic information 315. Visual information 305 is an example of, or includes aspects of, the corresponding element described with reference to FIG. 9. Textual information 310 is an example of, or includes aspects of, the corresponding element described with reference to FIG. 9. In some examples, visual information shows an image of a live video (e.g., shows images of persons, date, title, duration of time). Textual information shows text summary of a video. Acoustic information shows the audio feed of a video. In some examples, visual information, textual information, and acoustic information are from the same media file or same source file (e.g., video/transcript/audio based on a MP4 file). In some examples, visual information, textual information, and acoustic information are from multiple different media files (i.e., not extracted from a single source file).

FIG. 4 shows an example of a video recommendation application according to aspects of the present disclosure. Item recommendation apparatus 110 described in FIG. 1 can be implemented in a content recommendation pipeline to make recommendations based on viewer data (e.g., user profile) and video data. The example shown includes online viewer data 400, offline video data 405, graph data platform 410, data analysis library 415, machine learning library 420, item recommendation apparatus 425, and micro web framework 430. Item recommendation apparatus 425 is an example of, or includes aspects of, the corresponding element described with reference to FIGS. 1 and 5.

One or more embodiments of the present disclosure include a knowledge graph database constructed based on high speed and highly scalable database (e.g., Neo4j database). In some cases, a recommendation algorithm is implemented to make recommendations based on graph neural networks (GNNs).

According to some embodiments, online viewer data 400 and offline video data 405 are input to graph data platform 410 (e.g., Neo4j) for data integration. Neo4j is a graph database management system which includes a transactional database with native graph storage and processing. Powered by a native graph database, Neo4j stores and manages data in its more natural, connected state, maintaining data relationships, context for analytics, and a modifiable data model. Output from graph data platform 410 is then input to data analysis library 415 (e.g., Python® Pandas) for data pre-processing. Pandas is a software library written for the Python® programming language for data manipulation and analysis. Machine learning library 420 is used to train item recommendation apparatus 425. In some examples, machine learning library 420 includes PyTorch. PyTorch is a machine learning library based on the Torch library used for applications such as computer vision and natural language processing. Web demo using micro web framework 430 (e.g., Flask, which is a micro web framework written in Python®) illustrates increased performance of item recommendation apparatus 425.

### Network Architecture

In FIGS. 5-7, an apparatus and method for item recommendation are described. One or more embodiments of the apparatus and method include a knowledge graph component configured to generate a knowledge graph representing relationships between a plurality of users and a plurality of content items; a multi-modal graph encoder configured to generate a first feature embedding representing a user and a second feature embedding representing a content item of the plurality of content items based on the knowledge graph, wherein the second feature embedding is generated using a first modality for a query vector of an attention mechanism and a second modality for a key vector and a value vector of the attention mechanism; and a recommendation component configured to compare the first feature embedding to the second feature embedding to obtain similarity scores between the users and the content items and to identify recommended content items to the users based on the similarity scores.

Some examples of the apparatus and method further include an image encoder configured to generate a visual embedding for the content items, wherein the query vector is generated based on the visual embedding.

Some examples of the apparatus and method further include a text encoder configured to generate a textual embedding based on the content items, wherein the key vector is generated based on the textual embedding.

Some examples of the apparatus and method further include a training component configured to compute a loss function based on the first feature embedding and the second feature embedding and to update parameters of the multi-modal graph encoder based on the loss function.

In some examples, the multi-modal graph encoder comprises a symmetric bimodal attention network. In some examples, the symmetric bimodal attention network comprises a first multi-head attention module corresponding to the first modality and a second multi-head attention module corresponding to the second modality. Some examples of the apparatus and method further include a search component configured to search for a plurality of candidate content items for recommendation to the user.

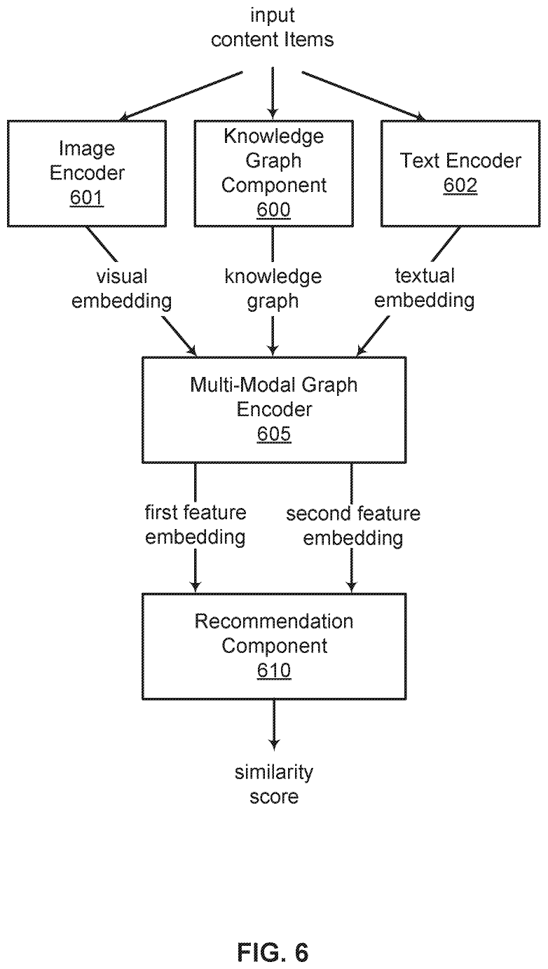

FIG. 5 shows an example of an item recommendation apparatus 500 according to aspects of the present disclosure. The example shown includes item recommendation apparatus 500, which includes processor unit 505, memory unit 510, I/O module 515, training component 520, recommendation component 525, search component 527, and machine learning model 530. Machine learning model 530 further includes knowledge graph component 535, and multi-modal graph encoder 540. Item recommendation apparatus 500 is an example of, or includes aspects of, the corresponding element described with reference to FIGS. 1 and 4. In some embodiments, item recommendation apparatus 500 includes an image encoder and a text encoder. The image encoder is configured to generate a visual embedding for content items. A text encoder is configured to generate a textual embedding based on the content items. Detail regarding the image encoder and the text encoder will be described in FIGS. 6 and 9.

A processor unit 505 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing.

Examples of a memory unit 510 include random access memory (RAM), read-only memory (ROM), or a hard disk. Examples of memory unit 510 include solid state memory and a hard disk drive. In some examples, memory unit 510 is used to store computer-readable, computer-executable software including instructions that, when executed, cause a processor to perform various functions described herein. In some cases, memory unit 510 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory unit 510 store information in the form of a logical state.

I/O module 515 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via I/O controller or via hardware components controlled by an I/O controller.

In some examples, I/O module 515 includes a user interface. A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, item recommendation apparatus 500 includes a computer implemented artificial neural network (ANN) for identifying high-level events and their respective vector representations occurring in a video. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

According to some embodiments, item recommendation apparatus 500 includes a convolutional neural network (CNN) for item recommendation. CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

A GCN is a type of neural network that defines convolutional operation on graphs and uses their structural information. For example, a GCN may be used for node classification (e.g., documents) in a graph (e.g., a citation network), where labels are available for a subset of nodes using a semi-supervised learning approach. A feature description for every node is summarized in a matrix and uses a form of pooling operation to produce a node level output. In some cases, GCNs use dependency trees which enrich representation vectors for key terms in an input phrase/sentence.

According to some embodiments, training component 520 receives training data including relationships between a set of users and a set of content items. In some examples, training component 520 computes a loss function based on the first feature embedding and the second feature embedding. Training component 520 updates parameters of the multi-modal graph encoder 540 based on the loss function. In some examples, training component 520 identifies a first content item and a second content item. Training component 520 determines that a user prefers the first content item over the second content item using similarity scores for the first content item and the second content item. Training component 520 computes a ranking loss based on the determination, where the loss function includes the ranking loss.

In some examples, training component 520 identifies a positive sample pair including a user and a first content item that is preferred by the user. Next, training component 520 identifies a negative sample pair including the user and a second content item that is not preferred by the user. Training component 520 then computes a contrastive learning loss based on the positive sample pair and the negative sample pair, where the loss function includes the contrastive learning loss.

According to some embodiments, training component 520 is configured to compute a loss function based on the first feature embedding and the second feature embedding and to update parameters of the multi-modal graph encoder 540 based on the loss function.

According to some embodiments, recommendation component 525 compares the first feature embedding to the second feature embedding to obtain a similarity score between the user and the second content item. In some examples, recommendation component 525 recommends the second content item for the user based on the similarity score. In some examples, recommendation component 525 computes a cosine similarity, where the similarity score is based on the cosine similarity.

According to some embodiments, recommendation component 525 is configured to compare the first feature embedding to the second feature embedding to obtain similarity scores between the users and the content items and to identify recommended content items to the users based on the similarity scores. Recommendation component 525 is an example of, or includes aspects of, the corresponding element described with reference to FIG. 6.

According to some embodiments, search component 527 is configured to search for a set of candidate content items for recommendation to the user. According to some embodiments, machine learning model 530 receives input indicating a relationship between a user and a first content item. In some cases, machine learning model 530 may be referred to as an item recommendation network or the network model.

According to some embodiments, knowledge graph component 535 generates a knowledge graph based on the input, where the knowledge graph includes relationship information between a node representing the user and a set of nodes corresponding to a set of content items including the first content item. In some examples, knowledge graph component 535 generates a spatial encoding matrix representing a number of hops between nodes of the knowledge graph, where the knowledge graph includes the spatial encoding matrix. In some examples, knowledge graph component 535 generates an edge encoding matrix representing edge types between nodes of the knowledge graph, where the knowledge graph includes the edge encoding matrix. In some examples, the edge types represent types of interactions between users and content items.

According to some embodiments, knowledge graph component 535 generates a knowledge graph based on the training data, where the knowledge graph represents the relationships between the set of users and the set of content items.

According to some embodiments, knowledge graph component 535 is configured to generate a knowledge graph representing relationships between a set of users and a set of content items. Knowledge graph component 535 is an example of, or includes aspects of, the corresponding element described with reference to FIG. 6.

According to some embodiments, multi-modal graph encoder 540 generates a first feature embedding representing the user and a second feature embedding representing a second content item of the set of content items based on the knowledge graph, where the second feature embedding is generated using a first modality for a query vector of an attention mechanism and a second modality for a key vector and a value vector of the attention mechanism. In some examples, an image encoder (see FIG. 6) generates a visual embedding for the second content item, where the query vector is generated based on the visual embedding. In some examples, a text encoder (see FIG. 6) generates a textual embedding based on the second content item, where the key vector is generated based on the textual embedding.

In some examples, multi-modal graph encoder 540 combines the query vector of the first modality and the key vector of the second modality to obtain a combined vector. Multi-modal graph encoder 540 weights the combined vector based on the knowledge graph to obtain a weighted vector. In some examples, multi-modal graph encoder 540 combines the weighted vector with the value vector of the second modality, where the second feature embedding is based on the combination of the weighted vector and the value vector. In some examples, multi-modal graph encoder 540 generates a first symmetric feature embedding using the first modality as the query vector and the second modality as the key vector. Multi-modal graph encoder 540 generates a second symmetric feature embedding using the second modality as a symmetric query vector and the first modality as a symmetric key vector, where the second feature embedding is based on the first symmetric feature embedding and the second symmetric feature embedding.

According to some embodiments, multi-modal graph encoder 540 generates a first feature embedding representing a user and a second feature embedding representing a content item of the set of content items based on the knowledge graph, where the second feature embedding is generated using a first modality as a query vector of an attention mechanism and a second modality as a key vector of the attention mechanism.

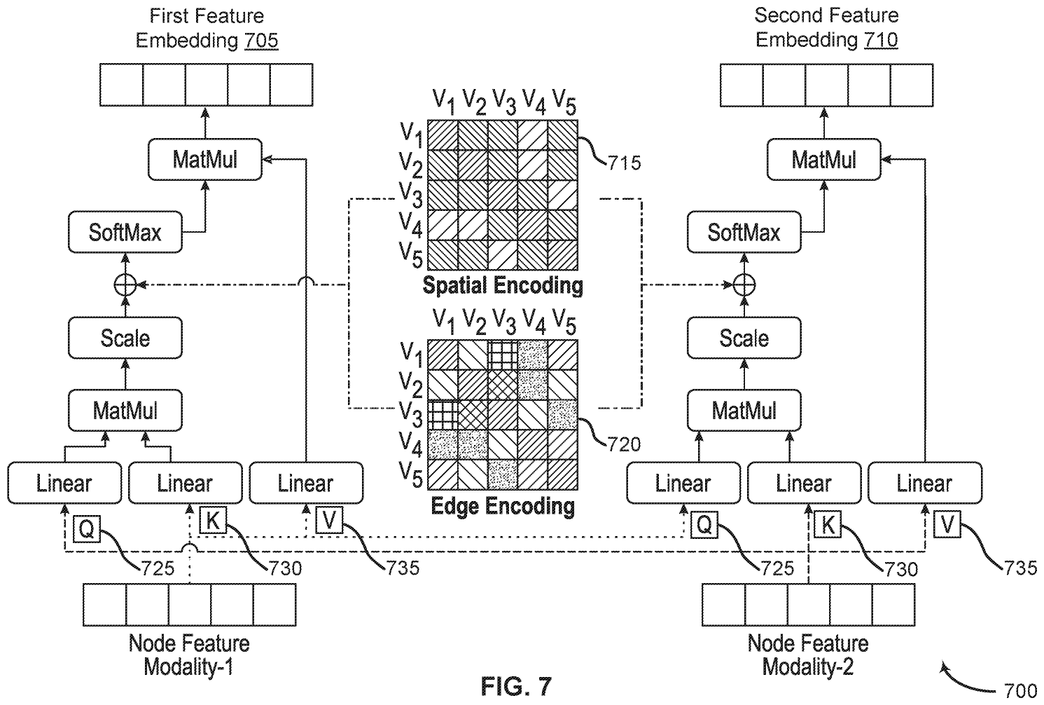

In some examples, the multi-modal graph encoder 540 includes a symmetric bimodal attention network. In some examples, the symmetric bimodal attention network includes a first multi-head attention module corresponding to the first modality and a second multi-head attention module corresponding to the second modality. Multi-modal graph encoder 540 is an example of, or includes aspects of, the corresponding element described with reference to FIGS. 6 and 7.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

FIG. 6 shows an example of a machine learning model for item recommendation according to aspects of the present disclosure. The machine learning model of FIG. 6 shows the relationship between elements of the item recommendation apparatus described with reference to FIG. 5. The example shown includes knowledge graph component 600, image encoder 601, text encoder 602, multi-modal graph encoder 605, and recommendation component 610.

As illustrated in FIG. 6, from top to bottom, knowledge graph component 600 receives input which indicates relationship between a user and a set of content items. Knowledge graph component 600 is an example of, or includes aspects of, the corresponding element described with reference to FIG. 5. Knowledge graph component 600 outputs a knowledge graph. Content items are input to image encoder 601 and text encoder 602. Image encoder 601 is configured to generate a visual embedding for the content items, where the query vector is generated based on the visual embedding. Text encoder 602 is configured to generate a textual embedding based on the content items, wherein the key vector is generated based on the textual embedding. The knowledge graph, the visual embedding, and the textual embedding are input to multi-modal graph encoder 605. Multi-modal graph encoder 605 is an example of, or includes aspects of, the corresponding element described with reference to FIGS. 5 and 7.

Multi-modal graph encoder 605 generates a first feature embedding and a second feature embedding, which are input to recommendation component 610. Recommendation component 610 compares the first feature embedding to the second feature embedding to obtain a similarity score between a user and a content item. Recommendation component 610 recommends a content item from the set of content items for a user based on the similarity score. Recommendation component 610 is an example of, or includes aspects of, the corresponding element described with reference to FIG. 5.

FIG. 7 shows an example of a multi-modal graph encoder 700 according to aspects of the present disclosure. The machine learning model as described in FIG. 5 includes multi-modal graph encoder 700. The multi-modal graph encoder 700 is used to generate feature embeddings based on knowledge graph and input information (i.e., users, content items, and their relationships) as described in FIG. 6. The example shown includes multi-modal graph encoder 700, first feature embedding 705, second feature embedding 710, spatial encoding matrix 715, edge encoding matrix 720, query vector 725, key vector 730, and value vector 735. Multi-modal graph encoder 700 is an example of, or includes aspects of, the corresponding element described with reference to FIGS. 5 and 6.

According to some embodiments of the present disclosure, the item recommendation apparatus 500 (FIG. 5) includes a graph neural network (GNN) which further includes multi-modal information. In some cases, a double-stream symmetric bi-modal attention module is configured to model multiple modalities on knowledge graph(s). The machine learning model 530 (FIG. 5) is flexible and enables feature interactions between multiple modalities during the modeling process, which results in increased performance.

Multi-modal graph encoder 700 includes a symmetric bimodal attention (SBA) network. In some cases, the SBA network may also be referred to as a co-attention network. According to an embodiment, multi-modal graph encoder 700 can simultaneously process two or more modalities. Additionally, each modality has its own multi-head attention module. In some cases, query, and (key, value) pair do not use the same input from a single modality. That is, the query and (key, value) pair may depend on different input from different modalities. For example, the embedding in a first modality (i.e., modality 1) is used as the query vector 725 input for a second modality (i.e., modality 2) multi-head attention unit, while the embedding in the second modality (modality 2) is used as the query vector input 725 for the first modality (modality 1) multi-head attention unit. Multi-modal graph encoder 700 is configured for parallel sequential inputs, such as videos/transcripts, video/sound, etc. The node-edge relationship in the knowledge graph forms a complex relation between entities in a non-Euclidean space. According to an embodiment, the second feature embedding 710 is generated using a first modality for query vector 725 of an attention mechanism and a second modality for key vector 730 and value vector 735 of the attention mechanism. Additionally, the first feature embedding 705 is generated using the second modality for query vector 725 of an attention mechanism and the first modality for key vector 730 and value vector 735 of the attention mechanism.

According to an embodiment of the present disclosure, multi-modal graph encoder 700 incorporates additional spatial information. In some cases, the additional spatial information may be referred to as spatial encoding and edge encoding. Spatial encoding matrix 715 represents or includes spatial encoding information. Edge encoding matrix 720 represents or includes edge encoding information. For example, spatial encoding matrix 715 considers the hop-information between the nodes in the knowledge graph structure. Additionally, edge encoding matrix 720 corresponds to the heterogeneity of link connections, for example, different types of relations. In some examples, the relations may include “follows”, “views”, “creates”, etc.

### Inference

In FIGS. 8-11, a method, apparatus, and non-transitory computer readable medium for item recommendation are described. One or more embodiments of the method, apparatus, and non-transitory computer readable medium include receiving input indicating a relationship between a user and a first content item; generating a knowledge graph based on the input, wherein the knowledge graph comprises relationship information between a node representing the user and a plurality of nodes corresponding to a plurality of content items including the first content item; generating a first feature embedding representing the user and a second feature embedding representing a second content item of the plurality of content items using a multi-modal graph encoder based on the knowledge graph, wherein the second feature embedding is generated using a first modality for a query vector of an attention mechanism and a second modality for a key vector and a value vector of the attention mechanism; comparing the first feature embedding to the second feature embedding to obtain a similarity score between the user and the second content item; and recommending the second content item for the user based on the similarity score.

Some examples of the method, apparatus, and non-transitory computer readable medium further include generating a spatial encoding matrix representing a number of hops between nodes of the knowledge graph, wherein the knowledge graph includes the spatial encoding matrix.

Some examples of the method, apparatus, and non-transitory computer readable medium further include generating an edge encoding matrix representing edge types between nodes of the knowledge graph, wherein the knowledge graph includes the edge encoding matrix. In some examples, the edge types represent types of interactions between users and content items.

Some examples of the method, apparatus, and non-transitory computer readable medium further include generating a visual embedding for the second content item, wherein the query vector is generated based on the visual embedding.

Some examples of the method, apparatus, and non-transitory computer readable medium further include generating a textual embedding based on the second content item, wherein the key vector is generated based on the textual embedding.

Some examples of the method, apparatus, and non-transitory computer readable medium further include combining the query vector of the first modality and the key vector of the second modality to obtain a combined vector. Some examples further include weighting the combined vector based on the knowledge graph to obtain a weighted vector.

Some examples of the method, apparatus, and non-transitory computer readable medium further include combining the weighted vector with the value vector of the second modality, wherein the second feature embedding is based on the combination of the weighted vector and the value vector.

Some examples of the method, apparatus, and non-transitory computer readable medium further include generating a first symmetric feature embedding using the first modality as the query vector and the second modality as the key vector. Some examples further include generating a second symmetric feature embedding using the second modality as a symmetric query vector and the first modality as a symmetric key vector, wherein the second feature embedding is based on the first symmetric feature embedding and the second symmetric feature embedding.

Some examples of the method, apparatus, and non-transitory computer readable medium further include computing a cosine similarity, wherein the similarity score is based on the cosine similarity.

FIG. 8 shows an example of recommending a content item according to aspects of the present disclosure. In some examples, these operations are performed by a system including a processor executing a set of codes to control functional elements of an apparatus such as the item recommendation apparatus 110 of FIG. 1. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system receives input indicating a relationship between a user and a first content item. In some cases, the operations of this step refer to, or may be performed by, machine learning model as described with reference to FIG. 5. According to an embodiment, the recommendation system uses different types of information (i.e., not limited to one modality of input). In some cases, the first content item may include a video item. The system receives features involving the video such as upload time, application name, etc. and user profile information such as username, view history, etc. Additionally, multi-modal information includes visual, textual, acoustic information, or a combination thereof.

At operation 810, the system generates a knowledge graph based on the input, where the knowledge graph includes relationship information between a node representing the user and a set of nodes corresponding to a set of content items including the first content item. In some cases, the operations of this step refer to, or may be performed by, knowledge graph component as described with reference to FIGS. 5 and 6.

A knowledge graph captures node-edge relationship (i.e., entity-relation structure) connecting items with their corresponding attributes in a non-Euclidean space. In some examples, the knowledge graph includes both homogenous information and heterogenous information. For example, entities (represented as nodes in knowledge graphs) can be different types of objects. In some cases, a knowledge graph includes a spatial encoding matrix representing a number of hops between nodes of the knowledge graph, and an edge encoding matrix representing edge types between nodes of the knowledge graph.

At operation 815, the system generates a first feature embedding representing the user and a second feature embedding representing a second content item of the set of content items using a multi-modal graph encoder based on the knowledge graph, where the second feature embedding is generated using a first modality for a query vector of an attention mechanism and a second modality for a key vector and a value vector of the attention mechanism. In some cases, the operations of this step refer to, or may be performed by, multi-modal graph encoder as described with reference to FIGS. 5-7.

According to an embodiment, the multi-modal graph encoder can handle input information of different types (i.e., modalities such as visual, textual, or acoustic information) where each modality has its own multi-head attention module. In some examples, the query, and (key, value) pair are constructed using input from different modalities. For example, the embedding from a first modality (i.e., modality 1) is used as the query input for a second modality (i.e., modality 2) multi-head attention unit, while the embedding in the second modality (modality 2) is used as the query input for the first modality (modality 1) multi-head attention unit. Therefore, multi-modal graph encoder is able to handle parallel sequential inputs, such as videos/transcripts, video/sound, etc. Multi-modal features increase content understanding.

At operation 820, the system compares the first feature embedding to the second feature embedding to obtain a similarity score between the user and the second content item. In some cases, the operations of this step refer to, or may be performed by, recommendation component as described with reference to FIGS. 5 and 6. A similarity score is defined to measure a similarity between multiple content items or measure the similarity between users. The similarity score can also measure affinity between each user and each content item. For example, the similarity score can measure the affinity between user A registered on a video sharing platform and a video item stored in a database. In some examples, recommendations for users are generated by computing a product between video embeddings and user embeddings. Additionally, recommendations for videos are generated by comparing video embeddings and calculating a cosine similarity based on the comparison.

At operation 825, the system recommends the second content item for the user based on the similarity score. In some cases, the operations of this step refer to, or may be performed by, recommendation component as described with reference to FIGS. 5 and 6. In some examples, after a user logs on to a website, the website recommends videos tailored to the user on the web page based on the similarity score. Such personalized recommendations depend in part on the user's browsing history in the past, user connections with other users, etc. Additionally or alternatively, when a user watches a video, a list of related videos is shown on the side to promote the next video of interest in a single click. The above scenarios may also be categorized as video recommendations for users and video recommendations for videos.

FIG. 9 shows an example of item recommendation using a machine learning model according to aspects of the present disclosure. FIG. 9 illustrates a process of generating a prediction (i.e., a video item likely preferred by a user of a platform or a video item similar to another video) based on multi-modal information and knowledge graph. A multi-modal graph encoder as described in FIG. 5 is used to generate feature embeddings based on multi-modal information and relationships among a user and a set of content items. The example shown includes visual information 900, textual information 905, visual encoding 910, textual encoding 915, multi-modal graph encoding 920, knowledge graph 923, and prediction 925. Multi-modal graph encoding 920 is performed using the multi-modal graph encoder as described in FIG. 5.

According to an embodiment, an item recommendation network includes graph constructions, nodes, and relations. In some cases, knowledge graph 923 includes multiple types of entities and multiple types of relations between the entities. In some examples, a knowledge graph 923 includes five types of entities and five types of relations. A node may represent a video, viewer, streamer, etc. In some examples, knowledge graph 923 includes 331,790 nodes. Additionally, relations may link two nodes by defining a relationship between the nodes. In some examples, the recommendation network may include 2,253,641 relations that may relate to different types of relations such as views, follows, creates, etc. For example, the relation between a viewer and a streamer can be defined using “follows” relation since the viewer follows the streamer. Similarly, the relationship of a viewer and a video may be defined using “views” as the viewer views a video.

In some examples, the item recommendation network takes visual information 900 and textual information 905 (e.g., a video and text). A video feature embedding network (VFE) and a universal sentence embedding network (USE) may be used to obtain node embeddings corresponding to node feature modalities. That is, an image encoder is configured to generate visual encoding 910 while a text encoder is configured to generate textual encoding 915, Furthermore, a multi-modal graph encoder (MMGE) is used to model the encoding/embeddings by incorporating information from knowledge graph 923 (spatial encodings and edge encodings). Visual encoding 910 and textual encoding 915 are input to multi-modal graph encoding 920. Visual information 900 is an example of, or includes aspects of, the corresponding element described with reference to FIG. 3. Textual information 905 is an example of, or includes aspects of, the corresponding element described with reference to FIG. 3. The VFE or the image encoder is an example of, or includes aspects of, the corresponding element described with reference to FIG. 6. The USE or the text encoder is an example of, or includes aspects of, the corresponding element described with reference to FIG. 6.

Training the item recommendation network will be described in greater detail in FIGS. 12 to 14. In some cases, the item recommendation network computes the product between video embeddings and user embeddings and outputs recommendations for users based on the product. Additionally, the item recommendation network generates video embeddings and computes cosine similarities between video embeddings, where video recommendations are generated based on the similarity scores.

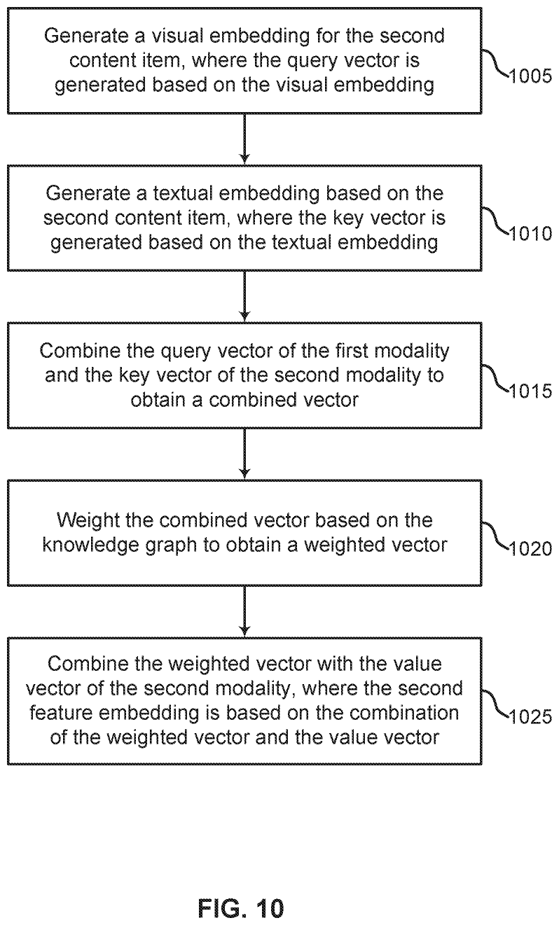

FIG. 10 shows an example of generating a multi-modal feature embedding according to aspects of the present disclosure. FIG. 10 illustrates a process of generating a query vector and a key vector described with reference to FIG. 8. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system generates a visual embedding for the second content item, where the query vector is generated based on the visual embedding. In some cases, the operations of this step refer to, or may be performed by, image encoder as described with reference to FIGS. 6 and 9. In some examples, the second content item includes a video and transcript describing the video. The system generates a visual embedding based on the video using a video feature embedding network as described in FIG. 9.

At operation 1010, the system generates a textual embedding based on the second content item, where the key vector is generated based on the textual embedding. In some cases, the operations of this step refer to, or may be performed by, text encoder as described with reference to FIGS. 6 and 9.

In some examples, the second content item includes a transcript or document describing the video. The system generates word embeddings corresponding to the transcript using a text encoder as described in FIG. 9. A word embedding is a learned representation for text where words that have the same meaning have a similar representation. Glove and Word2vec are examples of systems for obtaining a vector representation of words. GloVe is an unsupervised algorithm for training a network using on aggregated global word-word co-occurrence statistics from a corpus. Similarly, a Word2vec model may include a shallow neural network trained to reconstruct the linguistic context of words. GloVe and Word2vec models may take a large corpus of text and produces a vector space as output. In some cases, the vector space may have a large number of dimensions. Each word in the corpus is assigned a vector in the space. Word vectors are positioned in the vector space in a manner such that similar words are located nearby in the vector space. In some cases, an embedding space may include syntactic or context information in additional to semantic information for individual words.

At operation 1015, the system combines the query vector of the first modality and the key vector of the second modality to obtain a combined vector. In some cases, the operations of this step refer to, or may be performed by, multi-modal graph encoder as described with reference to FIGS. 5-7. According to an embodiment, the multi-modal graph encoder includes a transformer-based double stream architecture. The symmetric network uses a query vector Q, key vector K, and value vector V as tuple input to the multi-modal graph encoder. To model node embeddings of modality 1 (e.g., textual information), the multi-modal graph encoder uses the node embedding from modality 2 (e.g., visual information) as query vector Q for the transformer unit.

At operation 1020, the system weights the combined vector based on the knowledge graph to obtain a weighted vector. In some cases, the operations of this step refer to, or may be performed by, multi-modal graph encoder as described with reference to FIGS. 5-7. In some examples, matrix multiplication and scaling are applied to obtain the weighted vector. Additional information is added based on the spatial encoding matrix and the edge encoding matrix (see FIG. 7). In some examples, a SoftMax function is used as the last activation function of the multi-modal graph network to make a final prediction.

At operation 1025, the system combines the weighted vector with the value vector of the second modality, where the second feature embedding is based on the combination of the weighted vector and the value vector. In some examples, the multi-modal graph encoder combines the weighted vector with the value vector of the second modality to obtain the second feature embedding via matrix multiplication. The second feature embedding represents a content item of a set of content items. In some cases, the operations of this step refer to, or may be performed by, multi-modal graph encoder as described with reference to FIGS. 5-7.

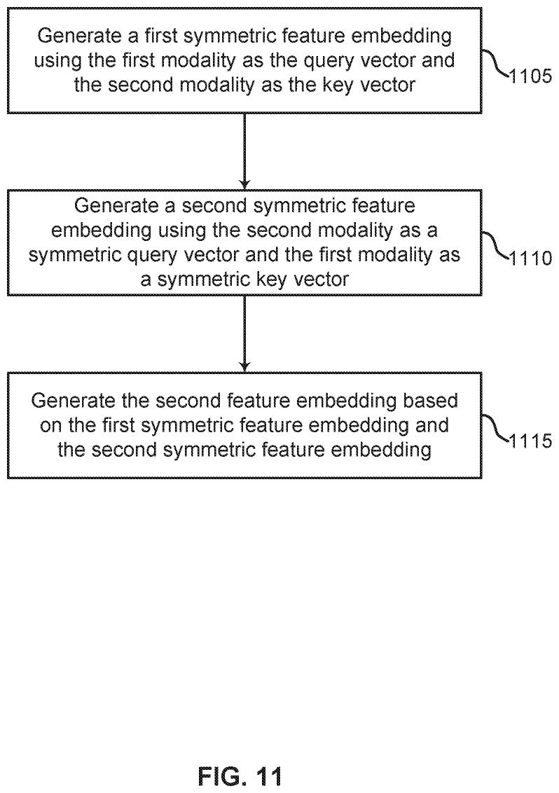

FIG. 11 shows an example of generating a symmetric feature embedding according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system generates a first symmetric feature embedding using the first modality as the query vector and the second modality as the key vector. In some cases, the operations of this step refer to, or may be performed by, multi-modal graph encoder as described with reference to FIGS. 5-7.

At operation 1110, the system generates a second symmetric feature embedding using the second modality as a symmetric query vector and the first modality as a symmetric key vector. In some cases, the operations of this step refer to, or may be performed by, multi-modal graph encoder as described with reference to FIGS. 5-7.

At operation 1115, the system generates the second feature embedding based on the first symmetric feature embedding and the second symmetric feature embedding. In some cases, the operations of this step refer to, or may be performed by, multi-modal graph encoder as described with reference to FIGS. 5-7.

### Training and Evaluation

In FIGS. 12-14, a method, apparatus, and non-transitory computer readable medium for training a neural network are described. One or more embodiments of the method, apparatus, and non-transitory computer readable medium include receiving training data including relationships between a plurality of users and a plurality of content items; generating a knowledge graph based on the training data, wherein the knowledge graph represents the relationships between the plurality of users and the plurality of content items; generating a first feature embedding representing a user and a second feature embedding representing a content item of the plurality of content items using a multi-modal graph encoder based on the knowledge graph, wherein the second feature embedding is generated using a first modality as a query vector of an attention mechanism and a second modality as a key vector of the attention mechanism; computing a loss function based on the first feature embedding and the second feature embedding; and updating parameters of the multi-modal graph encoder based on the loss function.

Some examples of the method, apparatus, and non-transitory computer readable medium further include identifying a first content item and a second content item. Some examples further include determining that a user prefers the first content item over the second content item using similarity scores for the first content item and the second content item. Some examples further include computing a ranking loss based on the determination, wherein the loss function includes the ranking loss.

Some examples of the method, apparatus, and non-transitory computer readable medium further include identifying a positive sample pair comprising a user and a first content item that is preferred by the user. Some examples further include identifying a negative sample pair comprising the user and a second content item that is not preferred by the user. Some examples further include computing a contrastive learning loss based on the positive sample pair and the negative sample pair, wherein the loss function includes the contrastive learning loss.

FIG. 12 shows an example of training a neural network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

During the training process, the parameters and weights of the machine learning model are adjusted to increase the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

At operation 1205, the system receives training data including relationships between a set of users and a set of content items. In some examples, training data includes different types of relations such as views, follows, creates, etc. The relation between a viewer and a streamer can be defined using “follows” relation since the viewer follows the streamer. Similarly, the relationship of a viewer and a video may be defined using “views” as the viewer views a video. In some cases, the operations of this step refer to, or may be performed by, training component as described with reference to FIG. 5.

At operation 1210, the system generates a knowledge graph based on the training data, where the knowledge graph represents the relationships between the set of users and the set of content items. According to an embodiment, the knowledge graph includes a spatial encoding matrix representing a number of hops between nodes of the knowledge graph, and an edge encoding matrix representing edge types between the nodes. In some cases, the operations of this step refer to, or may be performed by, knowledge graph component as described with reference to FIGS. 5 and 6.

At operation 1215, the system generates a first feature embedding representing a user and a second feature embedding representing a content item of the set of content items using a multi-modal graph encoder based on the knowledge graph, where the second feature embedding is generated using a first modality as a query vector of an attention mechanism and a second modality as a key vector of the attention mechanism. In some cases, the operations of this step refer to, or may be performed by, multi-modal graph encoder as described with reference to FIGS. 5-7.

At operation 1220, the system computes a loss function based on the first feature embedding and the second feature embedding. In some cases, the operations of this step refer to, or may be performed by, training component as described with reference to FIG. 5.

The term loss function refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

According to an embodiment of the present disclosure, the recommendation network includes an optimization objective as follows: [symbol] ᵣₐₙₖ= [symbol] −lnσ(u^{T}i−u^{T}i′)+λ|Θ|₂². A metric learning loss may include a neighboring contrastive (NC) loss or triplet loss, i.e., [symbol] _{metric}. Therefore, the total loss function is formulated as [symbol] ₜₒₜₐₗ= [symbol] ᵣₐₙₖ+ [symbol] _{metric}.

At operation 1225, the system updates parameters of the multi-modal graph encoder based on the loss function. In some cases, the operations of this step refer to, or may be performed by, training component as described with reference to FIG. 5. Some experiments are conducted to evaluate the item recommendation network over multiple scenarios and compare model performance. In some examples, performance may be compared using (1) conventional features only; (2) conventional features and visual features; (3) conventional features, visual features, and textual features.

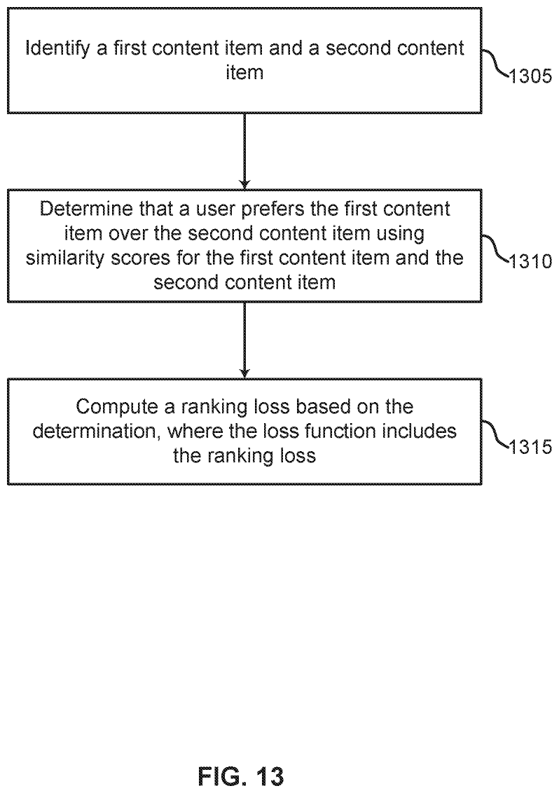

FIG. 13 shows an example of training a multi-modal graph encoder based on a ranking loss according to aspects of the present disclosure. Training component 520 described in FIG. 5 is used to train the multi-modal graph encoder. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system identifies a first content item and a second content item. In some cases, the operations of this step refer to, or may be performed by, training component as described with reference to FIG. 5.

At operation 1310, the system determines that a user prefers the first content item over the second content item using similarity scores for the first content item and the second content item. In some cases, the operations of this step refer to, or may be performed by, training component as described with reference to FIG. 5. In some examples, cosine similarity scores may be calculated between user embedding and first content item embedding. Cosine similarity scores may also be calculated between user embedding and second content item embedding. The training component determines that a user prefers the first content item over the second content item based on the cosine similarity scores.

At operation 1315, the system computes a ranking loss based on the determination, where the loss function includes the ranking loss. In some cases, the operations of this step refer to, or may be performed by, training component as described with reference to FIG. 5.

In some examples, a ranking loss is used to predict relative distances between inputs (also known as metric learning). A ranking loss function depends on a similarity score between data points. The similarity score can be binary (similar or dissimilar). The training component (see FIG. 5) extracts features from two (or three) input data points and obtains an embedded representation for each of them. Then, a metric function is defined to measure the similarity between those representations, e.g., Euclidean distance. The item recommendation apparatus is trained to produce similar representations for both inputs, in case the inputs are similar. Or the multi-modal graph encoder is trained to produce distant representations for the two inputs, in case they are dissimilar.

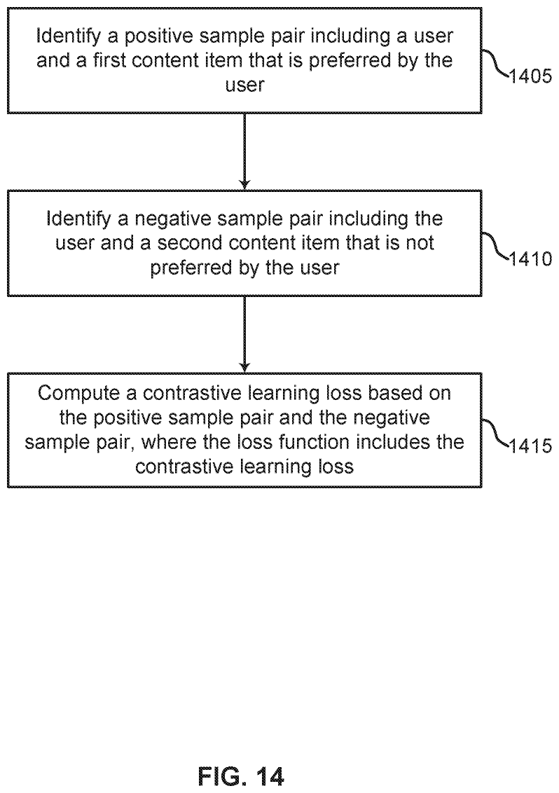

FIG. 14 shows an example of training a multi-modal graph encoder using contrastive learning according to aspects of the present disclosure. Training component 520 described in FIG. 5 is used to train the multi-modal graph encoder. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

The multi-modal graph encoder as described in FIGS. 5 and 7 is trained using contrastive learning. Contrastive learning refers to a type of machine learning in which a model is trained using the selection of positive and negative sample pairs. Contrastive learning can be used in either a supervised or unsupervised (e.g., self-supervised) training context. A loss function for a contrastive learning model can encourage a model to generate similar results for positive sample pairs, and dissimilar results for negative sample pairs. In self-supervised examples, positive samples can be generated automatically from input data (e.g., by cropping or transforming an existing image in image processing context).

At operation 1405, the system identifies a positive sample pair including a user and a first content item that is preferred by the user. In some cases, the operations of this step refer to, or may be performed by, training component as described with reference to FIG. 5.

In some examples, the multi-modal graph encoder is trained using a contrastive learning loss, which pushes apart dissimilar pairs (referred to as negative pairs) while pulling together similar pairs (referred to as positive pairs). In some examples, a first content item that is preferred by the user is identified as a positive sample. The first content item and the user form a positive pair. Additionally, a second content item that is not preferred by the user is identified as a negative sample. The second content item and the user form a negative pair.

At operation 1410, the system identifies a negative sample pair including the user and a second content item that is not preferred by the user. In some cases, the operations of this step refer to, or may be performed by, training component as described with reference to FIG. 5.

At operation 1415, the system computes a contrastive learning loss based on the positive sample pair and the negative sample pair, where the loss function includes the contrastive learning loss. In some cases, the operations of this step refer to, or may be performed by, training component as described with reference to FIG. 5. In some examples, the constative learning loss is computed based on the embeddings of the positive sample and the negative sample with regard to the user embedding.

Performance of apparatus, systems and methods of the present disclosure have been evaluated, and results indicate embodiments of the present disclosure have obtained increased performance over existing technology. Example experiments demonstrate that the item recommendation apparatus outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for item recommendation, comprising:
receiving input indicating a relationship between a user and a first content item;
generating a knowledge graph based on the input, wherein the knowledge graph comprises relationship information between a node representing the user and a plurality of nodes corresponding to a plurality of content items including the first content item;
generating a first feature embedding representing the user and a second feature embedding representing a second content item of the plurality of content items using a multi-modal graph encoder based on the knowledge graph, wherein the second feature embedding is generated using a first modality for a query vector of an attention mechanism and a second modality for a key vector and a value vector of the attention mechanism;
comparing the first feature embedding to the second feature embedding to obtain a similarity score between the user and the second content item; and
recommending the second content item for the user based on the similarity score.

2. The method of claim 1, further comprising:
generating a spatial encoding matrix representing a number of hops between nodes of the knowledge graph, wherein the knowledge graph includes the spatial encoding matrix.

3. The method of claim 1, further comprising:
generating an edge encoding matrix representing edge types between nodes of the knowledge graph, wherein the knowledge graph includes the edge encoding matrix.

4. The method of claim 3, wherein:
the edge types represent types of interactions between users and content items.

5. The method of claim 1, further comprising:
generating a visual embedding for the second content item, wherein the query vector is generated based on the visual embedding.

6. The method of claim 1, further comprising:
generating a textual embedding based on the second content item, wherein the key vector is generated based on the textual embedding.

7. The method of claim 1, further comprising:
combining the query vector of the first modality and the key vector of the second modality to obtain a combined vector; and
weighting the combined vector based on the knowledge graph to obtain a weighted vector.

8. The method of claim 7, further comprising:
combining the weighted vector with the value vector of the second modality, wherein the second feature embedding is based on the combination of the weighted vector and the value vector.

9. The method of claim 1, further comprising:
generating a first symmetric feature embedding using the first modality as the query vector and the second modality as the key vector; and
generating a second symmetric feature embedding using the second modality as a symmetric query vector and the first modality as a symmetric key vector, wherein the second feature embedding is based on the first symmetric feature embedding and the second symmetric feature embedding.

10. The method of claim 1, further comprising:
computing a cosine similarity, wherein the similarity score is based on the cosine similarity.

11. A method for training a neural network, comprising:
receiving training data including relationships between a plurality of users and a plurality of content items;
generating a knowledge graph based on the training data, wherein the knowledge graph represents the relationships between the plurality of users and the plurality of content items;
generating a first feature embedding representing a user and a second feature embedding representing a content item of the plurality of content items using a multi-modal graph encoder based on the knowledge graph, wherein the second feature embedding is generated using a first modality for a query vector of an attention mechanism and a second modality for a key vector and a value vector of the attention mechanism;
computing a loss function based on the first feature embedding and the second feature embedding; and
updating parameters of the multi-modal graph encoder based on the loss function.

12. The method of claim 11, further comprising:
identifying a first content item and a second content item;
determining that a user prefers the first content item over the second content item using similarity scores for the first content item and the second content item; and
computing a ranking loss based on the determination, wherein the loss function includes the ranking loss.

13. The method of claim 11, further comprising:
identifying a positive sample pair comprising a user and a first content item that is preferred by the user;
identifying a negative sample pair comprising the user and a second content item that is not preferred by the user; and
computing a contrastive learning loss based on the positive sample pair and the negative sample pair, wherein the loss function includes the contrastive learning loss.

14. An apparatus for item recommendation, comprising:
a knowledge graph component configured to generate a knowledge graph representing relationships between a plurality of users and a plurality of content items;
a multi-modal graph encoder configured to generate a first feature embedding representing a user and a second feature embedding representing a content item of the plurality of content items based on the knowledge graph, wherein the second feature embedding is generated using a first modality for a query vector of an attention mechanism and a second modality for a key vector and a value vector of the attention mechanism; and
a recommendation component configured to compare the first feature embedding to the second feature embedding to obtain similarity scores between the users and the content items and to identify recommended content items to the users based on the similarity scores.

15. The apparatus of claim 14, further comprising:
an image encoder configured to generate a visual embedding for the content items, wherein the query vector is generated based on the visual embedding.

16. The apparatus of claim 14, further comprising:
a text encoder configured to generate a textual embedding based on the content items, wherein the key vector is generated based on the textual embedding.

17. The apparatus of claim 14, further comprising:
a training component configured to compute a loss function based on the first feature embedding and the second feature embedding and to update parameters of the multi-modal graph encoder based on the loss function.

18. The apparatus of claim 14, wherein:
the multi-modal graph encoder comprises a symmetric bimodal attention network.

19. The apparatus of claim 18, wherein:
the symmetric bimodal attention network comprises a first multi-head attention module corresponding to the first modality and a second multi-head attention module corresponding to the second modality.

20. The apparatus of claim 14, further comprising:
a search component configured to search for a plurality of candidate content items for recommendation to the user.
